(19) United States
(12) Patent Application Publication
(10) Pub. No.: US 2025/0138896 A1
(43) Pub. Date: May 1, 2025

(54) SMART JOB GENERATION FOR INCIDENT RESPONSE

(71) Applicant: PagerDuty, Inc., San Francisco, CA (US)

(72) Inventors: Jake William Cohen, Santa Barbara, CA (US); Gregory West Schueler, Portland, OR (US); Ralph Alan Bird, Mafra (PT)

(21) Appl. No.: 18/496,057

(22) Filed: Oct. 27, 2023

(51) Int. Cl. G06F 9/50

(52) U.S. Cl. CPC G06F 9/5038

(57) ABSTRACT

Smart job generation for incident response includes receiving a natural language request to generate a job definition. The natural language request includes a natural language description of a job executable by a computing device. The natural language description of the job is decomposed into one or more tasks. Each task of the one or more tasks is a natural language description of a portion of the job. The job definition is generated. The job definition includes one or more instructions. At least one instruction of the one or more instructions corresponds to a task of the one or more tasks, such that performance of the at least one instruction accomplishes the task. The job definition is executed, by the computing device, to perform the job in response to an incident.

### TECHNICAL FIELD

This disclosure relates generally to computer operations and more particularly, but not exclusively to generating job for workflow automation using a language model.

### SUMMARY

A first aspect of the disclosed implementations is a method that includes receiving a natural language request to generate a job definition, where the natural language request includes a natural language description of a job executable by a computing device; decomposing the natural language description of the job into one or more tasks, where each task of the one or more tasks is a natural language description of a portion of the job; generating the job definition including one or more instructions, where at least one instruction of the one or more instructions corresponds to a task of the one or more tasks, such that performance of the at least one instruction accomplishes the task; and executing, by the computing device, the job definition to perform the job in response to an incident.

A second aspect of the disclosed implementations is a system that includes one or more memories and one or more processors. The one or more processors are configured to execute instructions stored in the memory to receive a natural language request to generate a job definition, where the natural language request includes a natural language description of a job, and where the job is capable of being performed, at least in part, by a computing device; decompose the natural language description of the job into one or more tasks, where each task of the one or more tasks is a natural language description of a portion of the job; generate the job definition including one or more instructions, where at least one instruction of the one or more instructions corresponds to a task of the one or more tasks, such that performance of the at least one instruction accomplishes the task; and execute, by the computing device, the job definition to perform the job in response to an incident.

A third aspect of the disclosed implementations is one or more non-transitory computer readable media that store instructions operable to cause one or more processors to perform operations that include receiving a natural language request to generate a job definition, where the natural language request includes a natural language description of a job, and where the job is capable of being performed, at least in part, by a computing device; decomposing the natural language description of the job into one or more tasks, where each task of the one or more tasks is a natural language description of a portion of the job; generating the job definition including one or more instructions, where at least one instruction of the one or more instructions corresponds to a task of the one or more tasks, such that performance of the at least one instruction accomplishes the task; and executing, by the computing device, the job definition to perform the job in response to an incident.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 shows components of one embodiment of a computing environment for event management.

FIG. 2 shows one embodiment of a client computer.

FIG. 3 shows one embodiment of a network computer that may at least partially implement one of the various embodiments.

FIG. 4 illustrates a logical architecture of a system for smart job for incident response.

FIG. 5 is a flowchart of a technique 500 for smart job definition for incident response.

FIGS. 6A-6B illustrate examples of user interfaces for receiving a request to create a job.

FIG. 6C illustrates examples of invalid natural language descriptions for creating a job.

FIG. 6D illustrates examples of valid natural language descriptions for creating a job.

FIG. 7 illustrates examples of training data and output training tasks.

FIG. 8A illustrates an example of a prefix that may be included in a job definition request.

FIG. 8B illustrates an example of a suffix that may be included in a job definition request.

FIG. 8C illustrates an example of a prompt that may be included in a job definition request.

FIG. 9 illustrates an example of a job definition template.

FIG. 10 illustrates an example of a job definition using a Hypertext Transfer Protocol (HTTP) command.

FIG. 11 illustrates an example of a job definition using a command line interface (CLI) command.

FIG. 12 illustrates an example of a job definition using a Structured Query Language (SQL) command.

FIG. 13 illustrates an example of a job definition using a Script command.

FIG. 14 illustrates an example of a user interface for previewing the received job definition.

FIG. 15 is a flowchart of a technique 1500 for smart job definition for incident response.

### DETAILED DESCRIPTION

An event management bus (EMB) is a computer system that may be arranged to monitor, manage, or compare the operations of one or more organizations. The EMB may be configured to accept various events that indicate conditions occurring in the one or more organizations. The EMB may be configured to manage several separate organizations at the same time. Briefly, an event can simply be an indication of a state of change to an information technology service of an organization. An event can be or describe a fact at a moment in time that may consist of a single or a group of correlated conditions that have been monitored and classified into an actionable state. As such, a monitoring tool of an organization may detect a condition in the IT environment (e.g., such as the computing devices, network devices, software applications, etc.) of the organization and transmit a corresponding event to the EMB. Depending on the level of impact (e.g., degradation of a service), if any, to one or more constituents of a managed organization, an event may trigger (e.g., may be, may be classified as, may be converted into) an incident. As such, an incident may be an unplanned disruption or degradation of service.

Non-limiting examples of events may include that a monitored operating system process is not running, that a virtual machine is restarting, that disk space on a certain device is low, that processor utilization on a certain device is higher than a threshold, that a shopping cart service of an e-commerce site is unavailable, that a digital certificate has or is expiring, that a certain web server is returning a 503 error code (indicating that web server is not ready to handle requests), that a customer relationship management (CRM) system is down (e.g., unavailable) such as because it is not responding to ping requests, and so on.

At a high level, an event may be received at an ingestion software of the EMB, accepted by the ingestion software, queued for processing, and then processed. Processing an event can include triggering (e.g., creating, generating, instantiating, etc.) a corresponding alert and a corresponding incident in the EMB, sending a notification of the incident to a responder (i.e., a person, a group of persons, etc.), and/or triggering a response (e.g., a resolution) to the incident. An alert (an alert object) may be created (instantiated) for anything that requires the performance (by a human or an automated task) an action. Thus, the alert may embody or include the action to be performed.

An incident associated with an alert may or may not be used to notify the responder who can acknowledge (e.g., assume responsibility for resolving) and resolve the incident. An acknowledged incident is an incident that is being worked on but is not yet resolved. The user that acknowledges an incident may be said to claim ownership of the incident, which may halt any established escalation processes. As such, notifications provide a way for responders to acknowledge that they are working on an incident or that the incident has been resolved. The responder may indicate that the responder resolved the incident using an interface (e.g., a graphical user interface) of the EMB.

When responding to an incident, a user (i.e., a responder) may document the steps taken during the response that led to a resolution. Additionally, the user may want to automate those steps so that future responses to the same or similar incident types can be handled via automation (i.e., a job). The steps may be grouped together and executed in a predefined order as a job. A job may be defined by a job definition. A job definition may detail each command to be executed and the order in which to execute the commands. As such, a job definition includes an ordered set of steps.

Users may lack the technical skills required to define or describe the steps of the job in such ways that the steps of the job are executable by a computer system, such as an EMB. Additionally, creating a job is error prone and malicious job creators may generate malicious jobs. Thus, it is desirable to have a system (an EMB) that can minimize the level of involvement of users in creating jobs and limit the role of users to providing natural language, high level descriptions of jobs rather than providing instructions executable by the system.

However, existing systems lack the technical capabilities to generate a job definition from a user's natural language request. When users create jobs, they might inadvertently or purposefully introduce invalid, erroneous, or malicious steps. Such missteps can strain resources, hindering overall performance and potentially causing certain operations to fail from resource depletion. This strain can lead to the need for significant additional investments in processing, memory, and storage resources. Additionally, the increased resource usage can heighten energy consumption and its related emissions, both from powering enhanced resources and from transmitting intermediate data over the network.

A system that can generate a job definition based on a request (i.e., a natural language request) that includes a natural language description of the job is desirable to reduce user interaction and increase overall system performance. The system may receive the natural language request to generate a job and, using a language model, may generate a series of tasks that are required to be performed to complete the job. The tasks can represent the required actions that may be performed to complete the job and can indicate the respective protocols to use to perform the tasks. The tasks may be thought of as a decomposition of the provided job definition into a list of individual steps that are described in natural language.

After receiving the series of tasks, the system may generate a job definition generation request that the system transmits to the language model along with training data. The language model may use the series of tasks along with the training data to generate a job definition. The job definition includes a series of steps. One or more steps may correspond to a single task. The training data are used to train the language model as to how various tasks are to be converted into commands using the provided method (e.g., protocol). The resulting commands are used to generate a step within the job definition. The resulting job definition is then used to generate the requested job.

Implementations according to this disclosure can reduce the risk of erroneous or malicious steps being added to a job which will lead to a decrease in the number of resources consumed by the system and increase overall efficiency. Additionally, for users who do not already know how to create a job, the system can be used to help train users on how a job is defined and how the steps are structured just by asking the system to generate a job, using a natural language, that the user is required to complete.

The term “organization” or “managed organization” as used herein refers to a business, a company, an association, an enterprise, a confederation, or the like.

The term “event,” as used herein, can refer to one or more outcomes, conditions, or occurrences that may be detected (e.g., observed, identified, noticed, monitored, received, etc.) by an event management bus. An event management bus (which can also be referred to as an event ingestion and processing system) may be configured to monitor various types of events depending on the needs of an industry and/or technology area. For example, information technology services may generate events in response to one or more conditions, such as, computers going offline, memory overutilization, CPU overutilization, storage quotas being met or exceeded, applications failing or otherwise becoming unavailable, networking problems (e.g., latency, excess traffic, unexpected lack of traffic, intrusion attempts, or the like), electrical problems (e.g., power outages, voltage fluctuations, or the like), customer service requests, or the like, or combination thereof. An event (e.g., an event object) may be directly created (such as by a human) in the EMB via user interfaces of the EMB.

Events may be provided to the event management bus using one or more messages, emails, telephone calls, library function calls, application programming interface (API) calls, including, any signals provided to an event management bus indicating that an event has occurred. One or more third party and/or external systems may be configured to generate event messages that are provided to the event management bus.

The term “responder,” as used herein, can refer to a person or entity, represented or identified by persons, that may be responsible for responding to an event associated with a monitored application or service. A responder is responsible for responding to one or more notification events. For example, responders may be members of an information technology (IT) team providing support to employees of a company. Responders may be notified if an event or incident they are responsible for handling at that time is encountered. In some embodiments, a scheduler application may be arranged to associate one or more responders with times that they are responsible for handling particular events (e.g., times when they are on-call to maintain various IT services for a company). A responder that is determined to be responsible for handling a particular event may be referred to as a responsible responder. Responsible responders may be considered to be on-call and/or active during the period of time they are designated by the schedule to be available.

The term “incident” as used herein can refer to a condition or state in the managed networking environments that requires some form of resolution by a person or an automated service. Typically, incidents may be a failure or error that occurs in the operation of a managed network and/or computing environment. One or more events may be associated with one or more incidents. However, not all events are associated with incidents.

The term “incident response” as used herein can refer to the actions, resources, services, messages, notifications, alerts, events, or the like, related to resolving one or more incidents. Accordingly, services that may be impacted by a pending incident, may be added to the incident response associated with the incident. Likewise, resources responsible for supporting or maintaining the services may also be added to the incident response. Further, log entries, journal entries, notes, timelines, task lists, status information, or the like, may be part of an incident response.

The term “notification message,” “notification event,” or “notification” as used herein can refer to a communication provided by an incident management system to a message provider for delivery to one or more responsible resources or responders. A notification event may be used to inform one or more responsible resources that one or more event messages were received. For example, in at least one of the various embodiments, notification messages may be provided to the one or more responsible resources using SMS texts, MMS texts, email, Instant Messages, mobile device push notifications, HTTP requests, voice calls (telephone calls, Voice Over IP calls (VOIP), or the like), library function calls, API calls, URLs, audio alerts, haptic alerts, other signals, or the like, or combination thereof.

The term “team” or “group” as used herein refers to one or more responders that may be jointly responsible for maintaining or supporting one or more services or systems for an organization.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

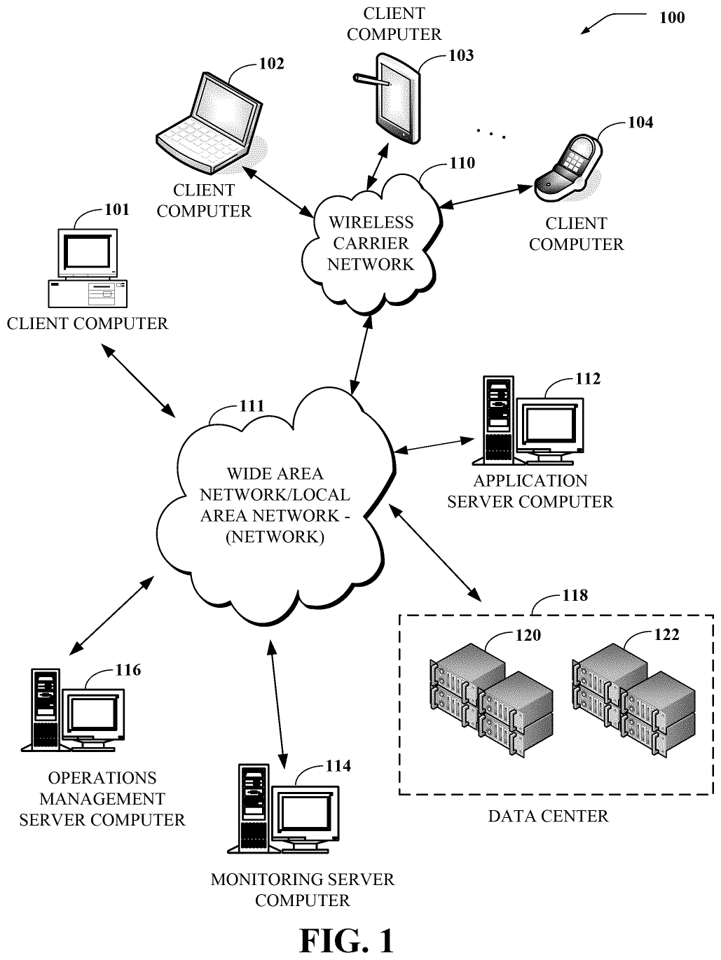

FIG. 1 shows components of one embodiment of a computing environment 100 for event management. Not all the components may be required to practice various embodiments, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement an EMB.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IoT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one embodiment, at least some of the client computers 102-104 may operate over wired and/or wireless network. Today, many of these devices include a capability to access and/or otherwise communicate over a network such as the network 111 and/or the wireless network 110. Moreover, the client computers 102-104 may access various computing applications, including a browser, or other web-based application.

In one embodiment, one or more of the client computers 101-104 may be configured to operate within a business or other entity to perform a variety of services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other embodiments. Further, it should be recognized that more or less client computers may be included within a system such as described herein, and embodiments are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), HTML5, or the like, to display and send a message. In one embodiment, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. The wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. The network 111 can include any communication method by which information may travel between computing devices.

Additionally, communication media typically embodies computer-readable instructions, data structures, program modules, or other transport mechanisms and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

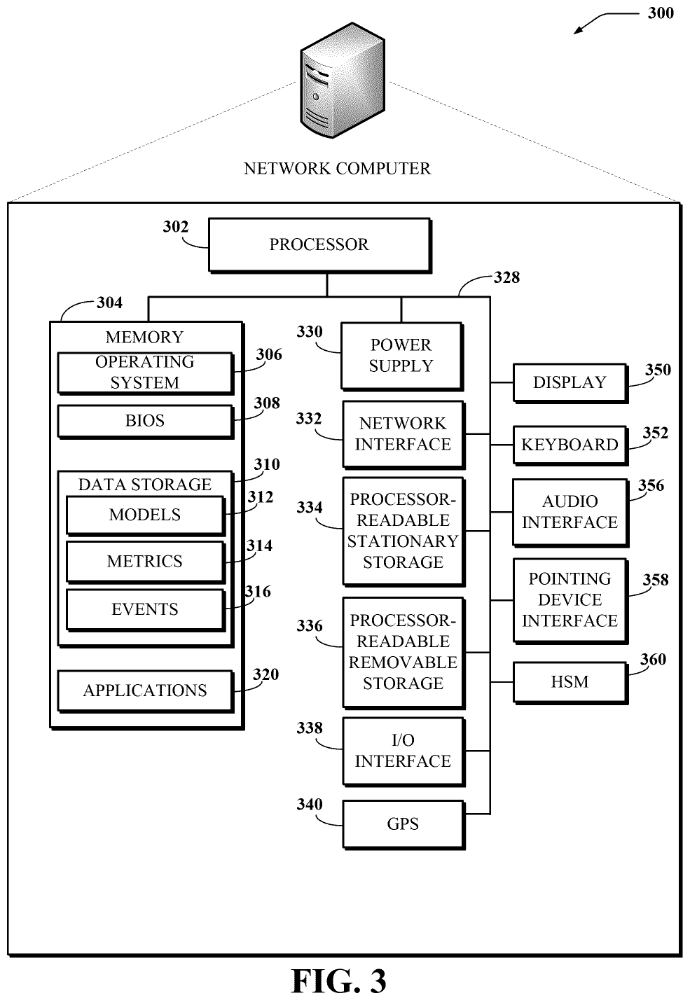

The operations management server computer 116 may include virtually any network computer usable to provide computer operations management services, such as a network computer, as described with respect to FIG. 3. In one embodiment, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

In at least one of the various embodiments, the monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some embodiments, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the invention is not so limited. Thus, the operations management server computer 116 may represent a plurality of network computers. For example, in one embodiment, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some embodiments, one or more data centers, such as a data center 118, may be communicatively coupled to the wireless network 110 and/or the network 111. In at least one of the various embodiments, the data center 118 may be a portion of a private data center, public data center, public cloud environment, or private cloud environment. In some embodiments, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some embodiments, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may be vary depending on the demands of individual users, cloud network arrangement, operational loads, performance considerations, application needs, operational policy, or the like. In at least one of the various embodiments, the data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

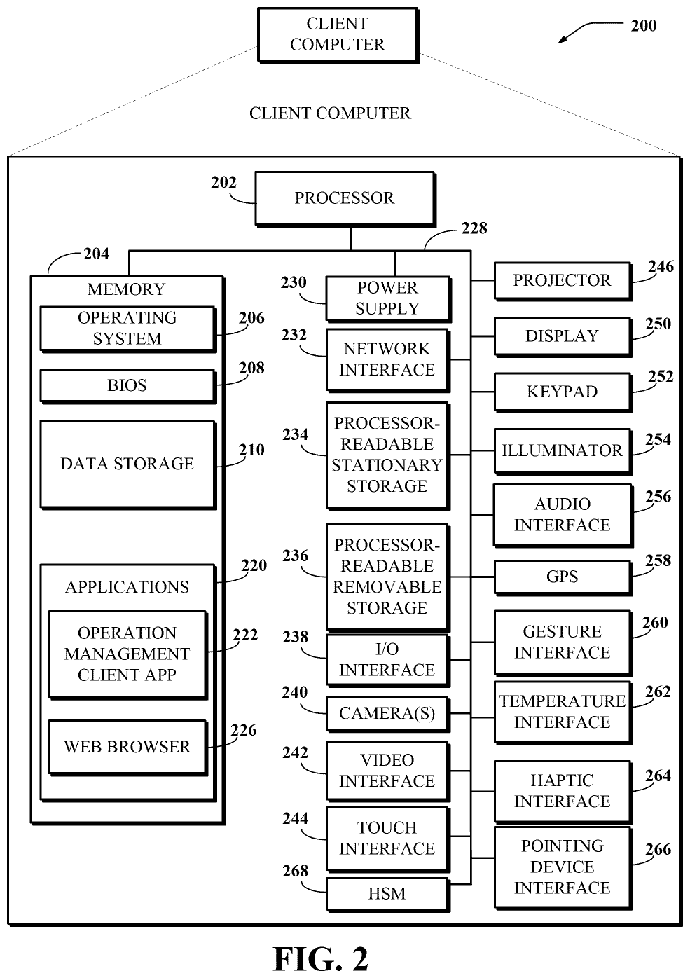

FIG. 2 shows one embodiment of a client computer 200. The client computer 200 may include more or less components than those shown in FIG. 2. The client computer 200 may represent, for example, at least one embodiment of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) receiver 258, an open-air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one embodiment, although not shown, a gyroscope may be employed within the client computer 200 to measure or maintain an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open-air gesture interface 260 may sense physical gestures of a user of the client computer 200, for example, by using single or stereo video cameras, radar, a gyroscopic sensor inside a computer held or worn by the user, or the like. The camera 240 may be used to track physical eye movements of a user of the client computer 200.

The GPS transceiver 258 can determine the physical coordinates of the client computer 200 on the surface of the earth, which typically outputs a location as latitude and longitude values. The GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS transceiver 258 can determine a physical location for the client computer 200. In at least one embodiment, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 226 that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory may also store an operating system 206 for controlling the operation of the client computer 200. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one embodiment, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. In at least one of the various embodiments, the operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the client computer 200 may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one embodiment of network computer 300 that may at least partially implement one of the various embodiments. The network computer 300 may include more or less components than those shown in FIG. 3. The network computer 300 may represent, for example, one embodiment of at least one EMB, such as the operations management server computer 116 of FIG. 1, the monitoring server computer 114 of FIG. 1, or an application server computer 112 of FIG. 1. Further, in some embodiments, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one embodiment, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one embodiment, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may be or include executable instructions, which can be loaded or copied, in whole or in part, from non-volatile memory to volatile memory to be executed by the processor 302. For example, the applications 320 can include instructions for performing some or all of the techniques of this disclosure. For example, the applications 320 can include software, tools, instructions or the like for smart job definition for incident response. In at least one of the various embodiments, one or more of the applications may be implemented as modules or components of another application. Further, in at least one of the various embodiments, applications may be implemented as operating system extensions, modules, plugins, or the like.

Furthermore, in at least one of the various embodiments, at least some of the applications 320 may be operative in a cloud-based computing environment. In at least one of the various embodiments, these applications, and others, that include the management platform may be executing within virtual machines or virtual servers that may be managed in a cloud-based based computing environment. In at least one of the various embodiments, in this context the applications may flow from one physical network computer within the cloud-based environment to another depending on performance and scaling considerations automatically managed by the cloud computing environment. Likewise, in at least one of the various embodiments, virtual machines or virtual servers dedicated to at least some of the applications 320 may be provisioned and de-commissioned automatically.

In at least one of the various embodiments, the applications may be arranged to employ geo-location information to select one or more localization features, such as, time zones, languages, currencies, calendar formatting, or the like. Localization features may be used in user-interfaces and well as internal processes or databases. Further, in some embodiments, localization features may include information regarding culturally significant events or customs (e.g., local holidays, political events, or the like) In at least one of the various embodiments, geo-location information used for selecting localization information may be provided by the GPS transceiver 340. Also, in some embodiments, geolocation information may include information providing using one or more geolocation protocol over the networks, such as, the wireless network 108 or the network 111.

Also, in at least one of the various embodiments, at least some of the applications 320, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 360 may be a stand-alone network computer, in other cases, the HSM 360 may be arranged as a hardware card that may be installed in a network computer.

Additionally, in one or more embodiments (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

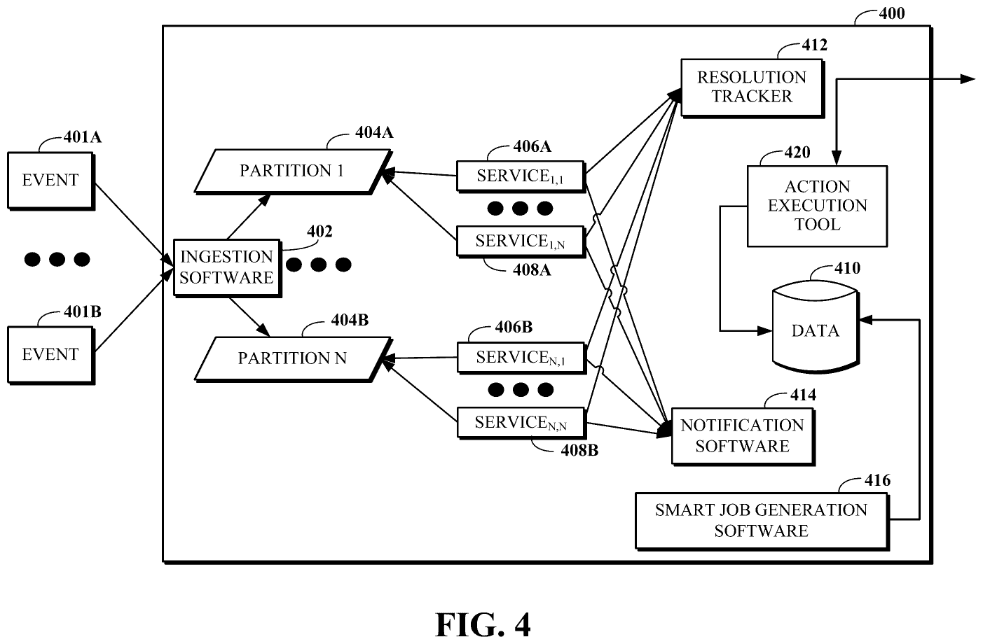

FIG. 4 illustrates a logical architecture of a system 400 for smart job definition generation for incident response automation.

In at least one of the various embodiments, a system for smart job definition for incident response may include various components. In this example, the system 400 includes an ingestion software 402, one or more partitions 404A-404B, one or more services 406A-406B and 408A-408B, a data store 410, a resolution tracker 412, a notification software 414, a smart job generation software 416, and an action execution tool 420.

One or more systems, such as monitoring systems, of one or more organizations may be configured to transmit events to the system 400 for processing. The system 400 may provide several services. A service may, for example, process an event and determine whether a downstream object (e.g., an incident) is to be triggered. As mentioned above, a received event may trigger an alert, which may trigger an incident, which in turn may cause notifications to be transmitted to responders.

A received event from an organization may include an indication of one or more services that are to operate on (e.g., process, etc.) the event. The indication of the service is referred to herein as a routing key. A routing key may be unique to a managed organization. As such, two events that are received from two different managed organizations for processing by the same service would include two different routing keys. A routing key may be unique to the service that is to receive and process an event. As such, two events associated with two different routing keys and received from the same managed organization for processing may be directed to (e.g., processed by) different services.

The ingestion software 402 may be configured to receive or obtain different types of events provided by various sources, here represented by events 401A, 401B. The ingestion software 402 may be configured to accept or reject received events. In an example, events may be rejected when events are received at a rate that is higher than a configured event-acceptance rate. If the ingestion software 402 accepts an event, the ingestion software 402 may place the event in a partition (such as one of the partitions 404A, 404B) for further processing. If an event is rejected, the event is not placed in a partition for further processing. The ingestion software may notify the sender of the event of whether the event was accepted or rejected. Grouping events into partitions can be used to enable parallel processing and/or scaling of the system 400 so that the system 400 can handle (e.g., process, etc.) more and more events and/or more and more organizations (e.g., additional events from additional organizations).

The ingestion software 402 may be arranged to receive the various events and perform various actions, including, filtering, reformatting, information extraction, data normalizing, or the like, or combination thereof, to enable the events to be stored (e.g., queued, etc.) and further processed. In at least one of the various embodiments, the ingestion software 402 may be arranged to normalize incoming events into a unified common event format. Accordingly, in some embodiments, the ingestion software 402 may be arranged to employ configuration information, including, rules, maps, dictionaries, or the like, or combination thereof, to normalize the fields and values of incoming events to the common event format. The ingestion software 402 may assign (e.g., associate, etc.) an ingested timestamp with an accepted event.

In at least one of the various embodiments, an event may be stored in a partition, such as one of the partition 404A or the partition 404B. A partition can be, or can be thought of, as a queue (e.g., a first-in-first-out queue) of events. FIG. 4 is shown as including two partitions (i.e., the partitions 404A and 404B). However, the disclosure is not so limited and the system 400 can include one or more than two partitions.

In an example, different services of the system 400 may be configured to operate on events of the different partitions. In an example, the same services (e.g., identical logic) may be configured to operate on the accepted events in different partitions. To illustrate, in FIG. 4, the services 406A and 408A process the events of the partition 404A, and the services 406B and 408B process the events of partition the 404B, where the service 406A and the service 406B execute the same logic (e.g., perform the same operations) of a first service but on different physical or virtual servers; and the service 408A and the service 408B execute the same logic of a second service but on different physical or virtual servers. In an example, different types of events may be routed to different partitions. As such, each of the services 406A-406B and 408A-408B may perform different logic as appropriate for the events processed by the service.

An (e.g., each) event, may also be associated with one or more services that may be responsible for processing the events. As such, an event can be said to be addressed or targeted to the one or more services that are to process the event. As mentioned above, an event can include or can be associated with a routing key that indicates the one or more services that are to receive the event for processing.

Events may be variously formatted messages that reflect the occurrence of events or incidents that have occurred in the computing systems or infrastructures of one or more managed organizations. Such events may include facts regarding system errors, warning, failure reports, customer service requests, status messages, or the like. One or more external services, at least some of which may be monitoring services, may collect events and provide the events to the system 400. Events as described above may be comprised of, or transmitted to the system 400 via, SMS messages, HTTP requests/posts, API calls, log file entries, trouble tickets, emails, or the like. An event may include associated metadata, such as, a title (or subject), a source, a creation time stamp, a status indicator, a region, more information, fewer information, other information, or a combination thereof, that may be tracked. In an example, the event data may be received as structured data, which may be formatted using JavaScript Object Notation (JSON), XML, or some other structured format. The metadata associated with an event is not limited in any way. The metadata included in or associated with an event can be whatever the sender of the event deems required.

In at least one of the various embodiments, a data store 410 may be arranged to store performance metrics, configuration information, or the like, for the system 400. In an example, the data store 410 may be implemented as one or more relational database management systems, one or more object databases, one or more XML databases, one or more operating system files, one or more unstructured data databases, one or more synchronous or asynchronous event or data buses that may use stream processing, one or more other suitable non-transient storage mechanisms, or a combination thereof.

Data related to events, alerts, incidents, notifications, other types of objects, or a combination thereof may be stored in the data store 410. For example, the data store 410 can include data related to resolved and unresolved alerts. For example, the data store 410 can include data identifying whether alerts are or are not acknowledged. For example, with respect to a resolved alert, the data store 410 can include information regarding the resolving entity that resolved the alert (and/or, equivalently, the resolving entity of the event that triggered the alert), the duration that the alert was active until it was resolved, other information, or a combination thereof. The resolving entity can be a responder (e.g., a human). The resolving entity can be an integration (e.g., automated system), which can indicate that the alert was auto-resolved. That the alert is auto-resolved can mean that the system 400 received, such as from the integration, an event indicating that a previous event, which triggered the alert, is resolved. The integration may be a monitoring system.

The data store 410 can be used to store jobs and job definitions. The template data can be used to identify (e.g., select, choose, infer, determine, etc.) a template for a job or a job definition.

In at least one of the various embodiments, the resolution tracker 412 may be arranged to monitor the details regarding how events, alerts, incidents, other objects received, created, managed by the system 400, or a combination thereof are resolved. In some embodiments, this may include tracking incident and/or alert life-cycle metrics related to the events (e.g., creation time, acknowledgement time(s), resolution time, processing time,), the resources that are/were responsible for resolving the events, the resources (e.g., the responder or the automated process) that resolved alerts, and so on. The resolution tracker 412 can receive data from the different services that process events, alerts, or incidents. Receiving data from a service by the resolution tracker 412 encompasses receiving data directly from the service and/or accessing (e.g., polling for, querying for, asynchronously being notified of, etc.) data generated (e.g., set, assigned, calculated by, stored, etc.) by the service. The resolution tracker can receive (e.g., query for, read, etc.) data from the data store 410. The resolution tracker can write (e.g., update, etc.) data in the data store 410.

While FIG. 4 is shown as including one resolution tracker 412, the disclosure herein is not so limited and the system 400 can include more than one resolution tracker. In an example, different resolution trackers may be configured to receive data from services of one or more partitions. In an example, each partition may be associated with one resolution tracker. Other configurations or mappings between partitions, services, and resolution trackers are possible.

The notification software 414 may be arranged to generate notification messages for at least some of the accepted events. The notification messages may be transmitted to responders (e.g., responsible users, teams) or automated systems. The notification software 414 may select a messaging provider that may be used to deliver a notification message to the responsible resource. The notification software 414 may determine which resource is responsible for handling the event message and may generate one or more notification messages and determine particular message providers to use to send the notification message.

In at least one of the various embodiments, a scheduler (not shown) may determine which responder is responsible for handling an incident based on at least an on-call schedule and/or the content of the incident. The notification software 414 may generate one or more notification messages and determine a particular message provider to use to send the notification message. Accordingly, the selected message providers may transmit (e.g., communicate, etc.) the notification message to the responder. Transmitting a notification to a responder, as used herein, and unless the context indicates otherwise, encompasses transmitting the notification to a team or a group. In some embodiments, the message providers may generate an acknowledgment message that may be provided to system 400 indicating a delivery status of the notification message (e.g., successful or failed delivery).

In at least one of the various embodiments, the notification software 414 may determine the message provider based on a variety of considerations, such as, geography, reliability, quality-of-service, user/customer preference, type of notification message (e.g., SMS or Push Notification, or the like), cost of delivery, or the like, or combination thereof. In at least one of the various embodiments, various performance characteristics of each message provider may be stored and/or associated with a corresponding provider performance profile. Provider performance profiles may be arranged to represent the various metrics that may be measured for a provider. Also, provider profiles may include preference values and/or weight values that may be configured rather than measured.

In at least one of the various embodiments, the smart job generation software 416 may be arranged to generate jobs based on a natural language description of a response to an event or an incident input by a user. The smart job generation software 416 may receive the natural language description from a user via a user interface, an API or any other suitable method. The smart job generation software 416 may generate a job using the natural language description in multiple steps. Additionally, the smart job generation software 416 may provide the language model with training data to be used in conjunction with the natural language description to generate the job.

The action execution tool 420 may receive actions selected by a responder. The action execution tool 420 may include facilities (e.g., tools, software, utilities, or the like) for transmitting the actions to, or causing the actions to be carried out by, IT components in the managed environments. For at least some of the actions, the IT components in the managed environments may return data (e.g., feedback data) to the action execution tool 420 indicating whether the actions were successful or other status data. That data is returned to the action execution tool 420 includes that the data are received by the resolution tracker 412, which stores the data in the data store 410, and those data used (e.g., retrieved) by the action execution tool 420 from the data store 410. The action execution tool 420 may store such status data in the data store 410. For example, the action execution tool 420 may store status data in association with corresponding actions and the alerts for which the actions were performed.

In at least one of the various embodiments, the system 400 may include various user-interfaces or configuration information (not shown) that enable organizations to establish how events should be resolved. Accordingly, an organization may define rules, conditions, priority levels, notification rules, escalation rules, routing keys, or the like, or combination thereof, that may be associated with different types of events. For example, some events (e.g., of the frequent type) may be informational rather than associated with a critical failure. Accordingly, an organization may establish different rules or other handling mechanics for the different types of events. For example, in some embodiments, critical events (e.g., rare or novel events) may require immediate (e.g., within the target lag time) notification of a response user to resolve the underlying cause of the event. In other cases, the events may simply be recorded for future analysis.

In an example, one or more of the user interfaces may be used to associate runbooks with certain types of objects. A runbook can include a set of actions that can implement or encapsulate a standard operating procedure for responding to (e.g., remediating, etc.) events of certain types. Runbooks can reduce toil. Toil can be defined as the manual or semi-manual performance of repetitive tasks. Toil can reduce the productivity of responders (e.g., operations engineers, developers, quality assurance engineers, business analysts, project managers, and the like) and prevents them from performing other value-adding work. In an example, a runbook may be associated with a template. As such, if an object matches the template, then the tasks of the runbook can be performed (e.g., executed, orchestrated, etc.) according to the order, rules, and/or workflow specified in the runbook. In another example, the runbook can be associated with a type. As such, if an object is identified as being of a certain type, then the tasks of the runbook associated with the certain type can be performed. A runbook can be assembled from predefined actions, custom actions, other types of actions, or a combination thereof.

In an example, one or more of the user interfaces may be used by responders to obtain information regarding objects and/or groups of objects. For example, a responder can use one of the user interfaces to obtain information regarding incidents assigned to or acknowledged by the responder. A user interface can be used to obtain information about an incident including the events (i.e., the group of events) associated with the incident. In an example, the responder can use the user interface to obtain information from the system 400 regarding the reason(s) a particular event was added to the group of events.

At least one of the services 406A-406B and 408A-408B may be configured to trigger alerts. A service can also trigger an incident from an alert, which in turn can cause notifications to be transmitted to one or more responders.

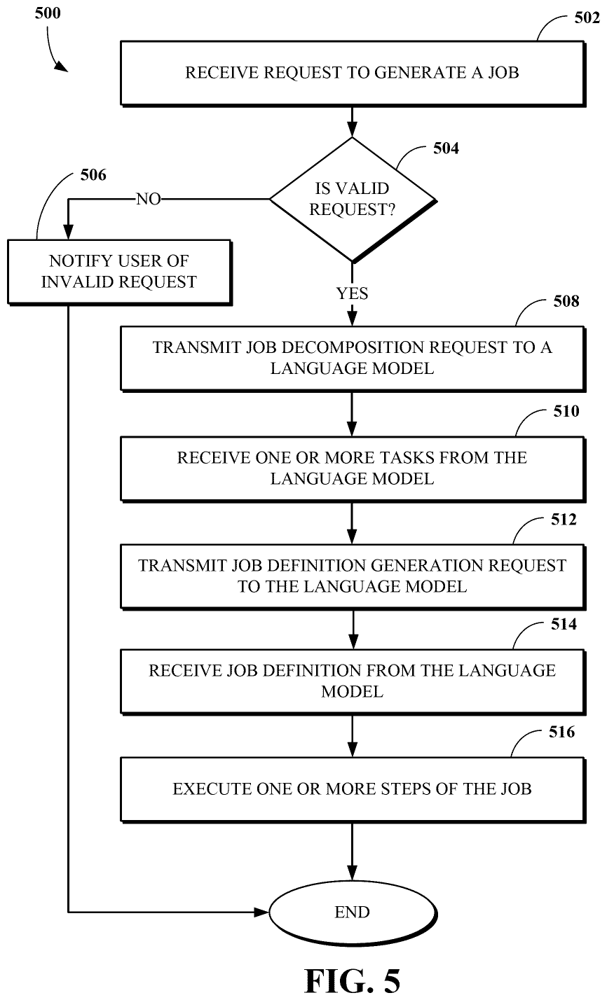

FIG. 5 includes a flowchart diagram of a technique 500 for smart job definition for incident response. The technique 500 includes operations 502 through 516, which are described below. The technique 500 can be stored in a memory (such as the memory 304, the processor readable stationary storage 334, the processor readable removeable storage 336 of FIG. 3, or any combination thereof) as instructions that can be executed by a processor (such as the processor 302 of FIG. 3) of a computer (such as the application server computer 112 of FIG. 1). In some implementations, some or all operations of the technique 500 may be performed on a client computer, such as by the client computer 101-104. In some other implementations, some or all operations of the technique 500 may be performed at the enclosure 120 or the enclosure 122, such as by the operations management server computer 116 at the data center 118.

At operation 502, a request to generate a job is received. The request may be received as input to a client computer (such as the client computer 101-104 of FIG. 1) and transmitted via a network (such as the wireless carrier network 110 or the network 111 of FIG. 1) to a network computer (such as the application server computer 112 of FIG. 1). The request may be received from a user, such as using a user interface of the system 400, or using an API, or using any combination thereof. The request may be received in a natural language, such as in the form of a goal or a set of tasks that is required to be completed. For example, the request may contain the following string “Add a comment to a ticket in System A.”

This allows the user to form their request for creating a job in a more natural way. In this way, the user requesting the new job does not need to understand how the job is created. That is, the user need not provide the specific technical commands or instructions executable by a computer to accomplish, for example, “add [ing] a comment to a ticket in System A.” All the user needs to provide is what the job needs to accomplish.

Additionally, a job must be defined using a job definition which may require knowledge of a specific syntax used to properly define each action and how that action should be executed by the job. The requesting user may not know what commands are required to perform the actions or how to properly structure the job definition, but the user does not need to. The user only needs to form the request using a natural language.

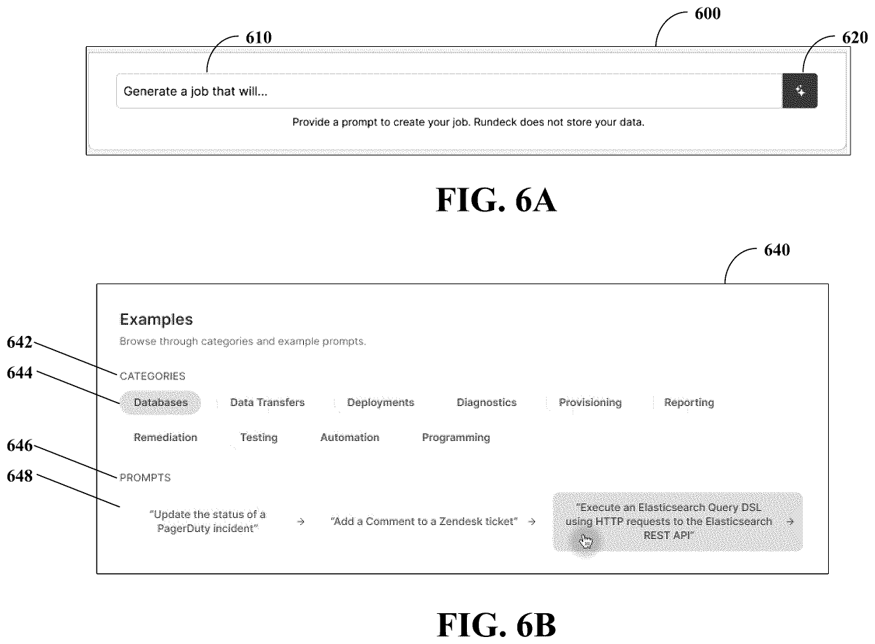

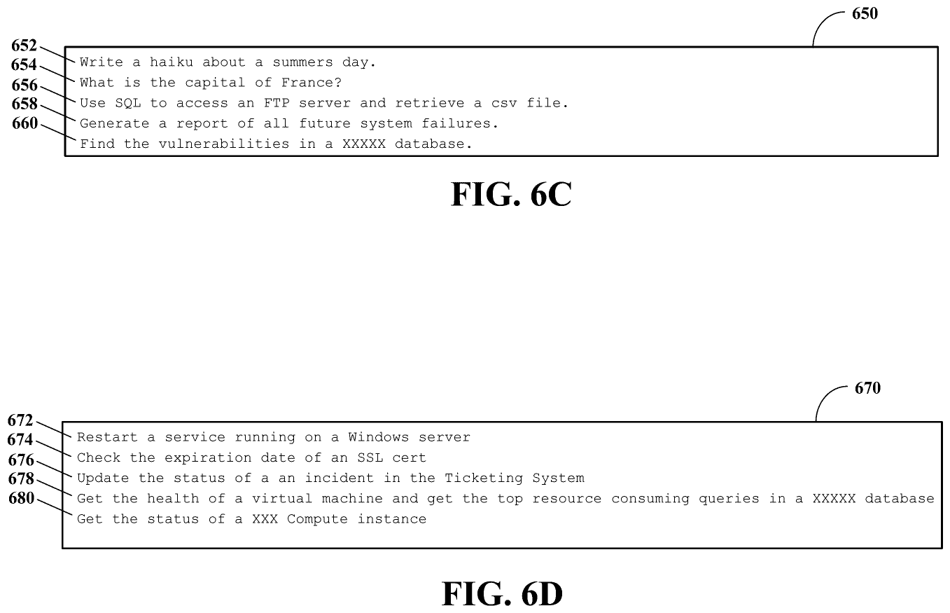

In the case of a human user, the system 400 can provide a user interface, such as user interfaces 600 and 640 of FIGS. 6A-6B, respectively. FIGS. 6A-6B are illustrations of the user interfaces 600 and 640 for receiving a request to create a job definition. Via the user interface 600, a user can enter a natural language description of the job using a job description input field 610. In the job description input field 610, the user may enter a natural language description of the job to be automated. After entering the natural language description, the user may invoke (e.g., click, touch, tap, etc.) a generate job button 620. Invoking the generate job button 620 may cause the technique 500 to generate the job.

The user interface 640 is an example of a helper for user interface 600 of FIG. 6A. The user interface 640 may help the user to enter a natural language description of the job by selecting a category 644, from a list of categories 642, and then selecting a prompt 648 from a list of prompts 646. A category 644 may be any logical grouping of prompts 648. For example, as depicted, the categories may be Database, Data Transfers, Deployments, Diagnostics, Provisioning, Reporting, Remediation, Testing, Automation, and Programming. While the aforementioned categories are used for demonstrative purposes, the categories may be any other logical group. The categories are not limited to only the listed categories.

Selecting a category 644 from the list may cause a list of prompts 646 to be displayed. The prompts 648 are suggestions (i.e., examples, samples, etc.,) that the user may start from. These prompts 648 may represent common tasks or common types of tasks that are required to be performed according to the selected category 644. In response the user selecting a prompt from the prompts 646, the prompt (i.e., the text of the prompt) is automatically added to the job description input field 610 of FIG. 6A. The user may select multiple prompts from the prompts 646 to populate the job description input field 610. A prompt can be added (e.g., inserted or appended) in the job description input field 610 at a location of the cursor.

Referring again to FIG. 5, at operation 504, the technique 500 determines whether the request is valid. After the user either enters a natural language description using the job description input field 610 and invokes the generate job button 620, the job description input field 610 is validated to ensure it is related to automation. As such the operation 504 will analyze the entered natural language description to determine whether the natural language description is related to a task that can be completed by the EMB. For example, the user may enter or select a prompt 648 such as, “Execute an Elasticsearch Query DSL using HTTP requests to the Elasticsearch REST API.” The operation 504 may analyze this request and determine that it is a valid request to create a job as the request is related to automating a particular request. On the other hand, the user may enter a natural language description such as, “Write me a poem about penguins.” The operation 504 may analyze this request and determine that it is not related to automation. As such the operation 504 may mark this request as invalid. If the request is determined to be valid, the technique 500 proceeds to operation 508; otherwise, the technique 500 proceeds to operation 506.

FIG. 6C illustrates examples 650 of invalid natural language description training data that may be used by technique 500 at operation 504 to help determine that the request is a valid request to create a job. FIG. 6C includes invalid natural language description training datum 652 through invalid natural language training datum 660. An invalid natural language training datum may include any natural language description that does not relate to automation, such as the invalid natural language description training datum 652 (e.g., “Write a haiku about a summer day”) or the natural language description training datum 654 (e.g., “What is the capital of France?”). As such the operation 504 may mark a similar request as invalid.

Additionally, a natural language description training datum may contain other natural language that appears to be related to automation but cannot be completed as described. For example, the natural language training datum 656 describes a request to “Use SQL to access an FTP Server and retrieve a csv file.” While the request may describe a job that may be completed using automation and is, as such, related to automation, it may not be able to be completed as described. In other words, the method or way of completing the described action may not be a valid method or way of completing the task (e.g., SQL cannot be used to access an FTP Server). In a further example, the natural language description may contain a description of a job that is not possible such as the natural language training datum 658 (e.g., “Generate a report of all future system failures”). In this case, the natural language description included in the training datum is describing a task that cannot be completed by automation. Automation cannot definitely identify future system failures and generate a report therefor in the present.

In another example, a natural language description training datum may include natural language that is ambiguous or overly broad, such as the invalid natural language training datum 660 (e.g., “Find the vulnerabilities in a XXX database”). Finding vulnerabilities may mean to look for security vulnerabilities, to look for relational issues or inconsistencies, or some other meaning. Additionally, it may not be clear what the vulnerabilities pertain to. As such the request may be to scan the database server for vulnerabilities or the request may be to scan a database, hosted on a database server for vulnerabilities. In either case, the description is ambiguous or not sufficiently specific such that automation tasks can be derived or identified therefor. As such, the technique 500, at operation 504, may mark such requests as invalid.

FIG. 6D illustrates examples 670 of valid natural language description training data that may be used by the technique 500 at the operation 504, which determines whether the request is valid for creating a job. FIG. 6D includes valid natural language description training datums 672 through 680. The valid natural language description training datums 672 through 680 may include any natural language description that is determined to relate to automation. For example, the valid natural language description training datum 672 (i.e., “Restart a service on a Windows® Server”) relates to automation since restarting a service is a clear action that can be performed by a job and the description includes the type of server on which the service to be restarted is executing. As such, the description includes sufficient information with sufficient specificity such that the action is automatable. Therefore, the technique 500, at operation 504, may mark such requests as valid.

The valid natural language description training datums 674 and 676 are valid descriptions of actions with sufficient detail and specificity such that the actions can be automated. The valid natural language description training datum 674 (e.g., “Check the expiration date of an SSL cert”) is a concise description of a simple task that may be performed autonomously. Additionally, valid natural language description training datum 676 (e.g., “Update the status of an incident in the Ticketing System”) may be a valid natural language description. In either case, the request includes a request for specific information from a specific resource or to perform a specific action on a specific type of resource. As such, similar requests may be marked as valid by operation 504 of FIG. 5.

While FIGS. 6C and 6D illustrate five examples of invalid natural language description training data and valid natural language training data, respectively, the invalid natural language description training data and the valid natural language training data may contain more or fewer training data.

In some embodiments, the operation 504 may send the valid natural language training data and the invalid natural language training data to the language model to determine if the natural language description is valid. Additionally, at least some of the valid natural language description training data and/or the invalid natural language description training data may include respective descriptions of why the natural language training datum is either valid or invalid, as the case may be. To illustrate, the invalid natural language training data may include an invalid natural language training datum such as the invalid natural language description training datum 652 (e.g., “Write a haiku about a summer day”). Optionally, the invalid natural language training datum may additionally include a description such as “this request is invalid because it is not related to automation.” In another illustration, the valid natural language training data may include a valid natural language training datum such as the valid natural language description training datum 672 (i.e., “Restart a service on a Windows® Server”). Optionally, the valid natural language training datum may additionally include a description such as “this request is valid because it can be completed using automation.”

At operation 506, a notification is displayed to a user that the request is invalid. The invalid request notification may be displayed in response to a determination from operation 504 that the request does not pertain to automation.

At operation 508, the technique 500 transmits a job decomposition request to a language model. The language model may be included in the system 400 or may be otherwise accessible to the system 400, such as using APIs associated with the language model. Using a natural language description and training data provided as a part of the job decomposition request, the operation 508 may generate (e.g., result in the generation of) a series of tasks. That is, the language model may determine the number of tasks required to complete the job described by the natural language description using the training data as guidance for how tasks should be formatted. Each task may have associated therewith a task description as well as a protocol. The series of tasks are then returned to the technique 500.

The job decomposition request may contain the natural language description entered in the job description input field 610 of FIG. 6A along with training data. The training data are used to teach (e.g., direct) the language model as to how the natural language description should be parsed into a series (e.g., a sequential list) of tasks. Each task is or may be considered to be an intermediate representation between the natural language description and the computer implementable or executable instructions. The language model may be a generative artificial intelligence model, a large language model, or the like. In an example, the language model may be included in the system 400 of FIG. 4. In another example, the language model may be remotely accessible by the technique 500. For example, the language model may be or may be included in a cloud-based system. The job decomposition request may be transmitted via the network 111 or the wireless carrier network 110 or communicated directly to another module of the system 400.

The job decomposition generation request may include the natural language description and training data. Each training datum can include a training natural language description and output training tasks. The training data may be used to train the language model on how the language model may format the series of tasks output for the natural language description.

A training datum of the training data may include a training natural language description as well as output training tasks. Each output training task may include a task description that is an intermediate representation of a section of the training natural language description and the computer implementable or executable instructions and a protocol. The protocol may be used to represent the type of command or instruction that will be used to accomplish the output training task. Each training natural language request may be represented by one or more output training tasks. As such each natural language request may be represented by one or more tasks (i.e., the series of tasks). For example, a task description may be “Stop a service on a Linux server” and the protocol may be CLI. The task description describes, in a natural language, a computer implementable or executable instruction, and the protocol describes the specific method or interface through which the computer implementable or executable instruction may be performed. In the given example, the protocol is CLI, which indicates that the stopping a service on a Linux server should be carried out using commands entered through a command line interface. The protocol specifies the technical means or mechanism by which the computer implementable or executable instruction described in the task description may be accomplished.

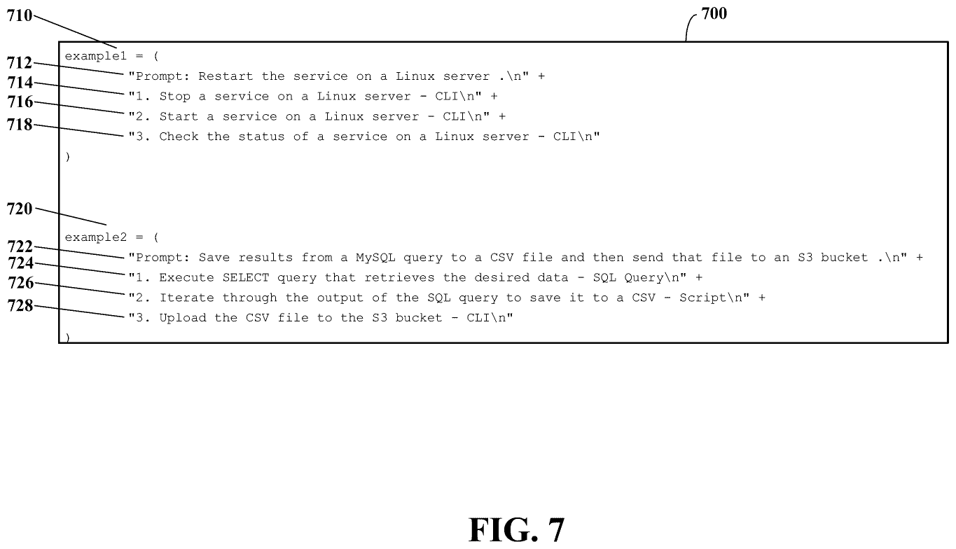

FIG. 7. illustrates examples 700 of training data (such as the training datum 710 and training datum 720) and output training tasks. The training datum 710 includes a training natural language description 712 and an output training tasks 714-718. The training datum 710 indicates to the language model that, given an input such as the training natural language description 712, the language model is to generate output that is and is in the format of the output training tasks 714-718. The training natural language description describes a job to restart a service on a Linux server (e.g., “Restart a service on a Linux server”). Corresponding output training tasks 714-718 are identified to the language model for the training natural language description 712. That is, the language model is to learn that a job described by the training natural language description 712 can be implemented by the three output training tasks 714-718.

An output training task 714 includes a task description to stop a service on a server and provides a protocol that may be used (i.e., “Stop a service on a Linux Server-CLI”). The training datum 710 additionally includes output training task 716 that may be started upon completion of the output training task 714. For example, the service may be restarted using the CLI (i.e., “Start a service on a Linux server-CLI”). Finally, the third and last task, output training task 718, is included. After the service is stopped and started, the system may check the status of the server using a CLI command (i.e., “Check the status of a service on a Linux server-CLI”).

In this example, all the protocols for each of the output training tasks 714-718 are the same (i.e., the protocol CLI). However, that may not be the case for all training data. Each output training task may have (or use) a different protocol. The protocol may be selected from a predefined list of protocols. The predefined list of protocols may include CLI, application programming interface (API), Script, Query, HTTP, or any other suitable protocol that can be used to automate a given task.

The training datum 720 includes training natural language request 722 (i.e., “Save the results from a MySQL query to a CSV file and then send that file to an S3 bucket”) and output training tasks 724-728. The output training task 724 includes a task description to execute a select query to retrieve the desired data and provides a protocol of SQL Query (i.e., “Execute SELECT query that retrieves the desired data-SQL Query”). The output training task 726 may be started upon completion of output training task 724. For example, the next action to be performed is to iterate through the returned records and save the result in a comma separated file using a script (i.e., “Iterate through the output of the SQL query and save it to a CSV-Script”). Finally, after saving the results to a comma separated file, the output training task 728 indicates that the file is to be uploaded to an S3 bucket using the CLI (i.e., “Upload the CSV file to the S3 bucket-CLI”).

While FIG. 7 illustrates two examples of training datum that may be included as a part of the training data implementation in accordance with this disclosure are not limited to only those examples. Other implementations may include more or less training datum. The training data used may be the same as the training data described; however, implementations are not limited only to these examples provided.

Referring again to FIG. 5, at operation 510, the series of tasks generated by the language model based on the job decomposition request may be received. At operation 512, a job definition generation request may be transmitted to the language model. The job definition generation request may include the series of tasks and job definition training data. Each job definition training datum may include training tasks with output job definition. The output job definition is an example of a job definition that may be executed by the action execution tool 420 of the system 400. The output job definition may include a series of steps in which each step details the instructions, as well as any required inputs, for completing a task.

The series of steps may correspond to (or may be generated for) a task of the series of tasks. Whereas a task, via the task description, represents the action that is to be performed, and the protocol describes how to accomplish that action. The steps, on the other hand, are the instructions that outline how to perform the action using the protocol specified. One or more of the instructions may be in whole or in part computer executable instructions that can be carried out by a component of the system 400 of FIG. 4. One or more of the instructions may be manual instructions that are to be carried by a human. As such, while the tasks are or may be an intermediate representation between the natural language description the computer implementable or executed instructions, the series of steps may include computer implementable or executed instructions. To illustrate, and with reference to the output training task 714 of FIG. 7, the step generated by the language model may be or include the command “systemct1 stop apache2” as the actual CLI command to execute to perform this action.

The job definition request may also include a prefix and a suffix. The prefix may be used to provide detailed instructions to the language model as to how the job definition training data, natural language description, and the series of tasks may be utilized to generate the job definition. The suffix may be used to provide the language model with detailed instructions as to how the language model is to format the job definition.

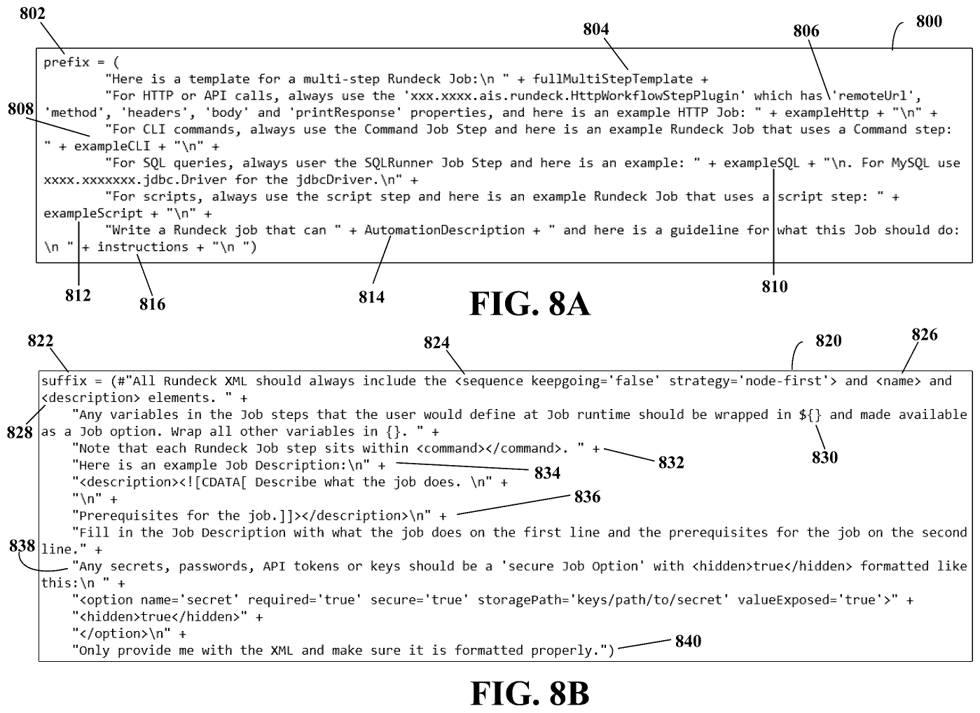

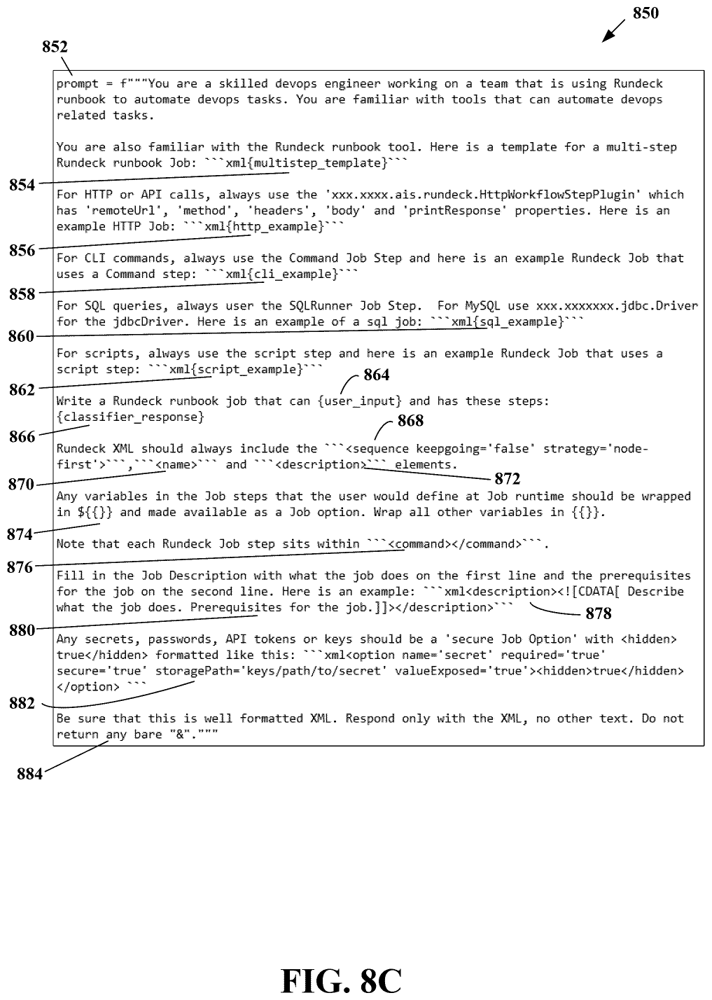

FIG. 8A is an illustration 800 of a prefix 802. The prefix 802 provides the language model with job definition training data 804-812 and instructs the language model to generate a job definition for the natural language description (i.e., AutomationDescription 814) using the series of tasks (i.e., instructions 816). The job definition training datum 804 is a template of a multi-step automation job definition. A automation job definition specifies the sequence of steps to be executed, potentially across different nodes, in an organized and repeatable manner. It is akin to a script or playbook, which may include additional features such as scheduling, logging, and notification capabilities. An automation job may be integrated in or called from an automated workflow to carry out the steps of the automation job. The automation job definition may be templatized (e.g., includes placeholders or variables) that may be replaced (e.g., resolved) when the automation job is executed based on the run time context.

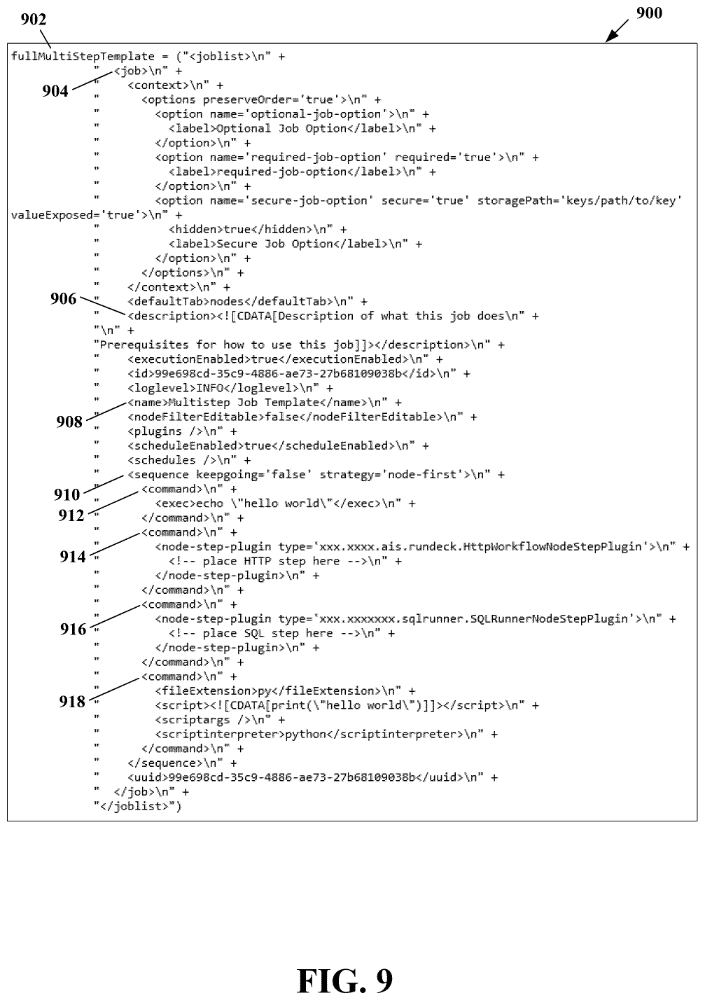

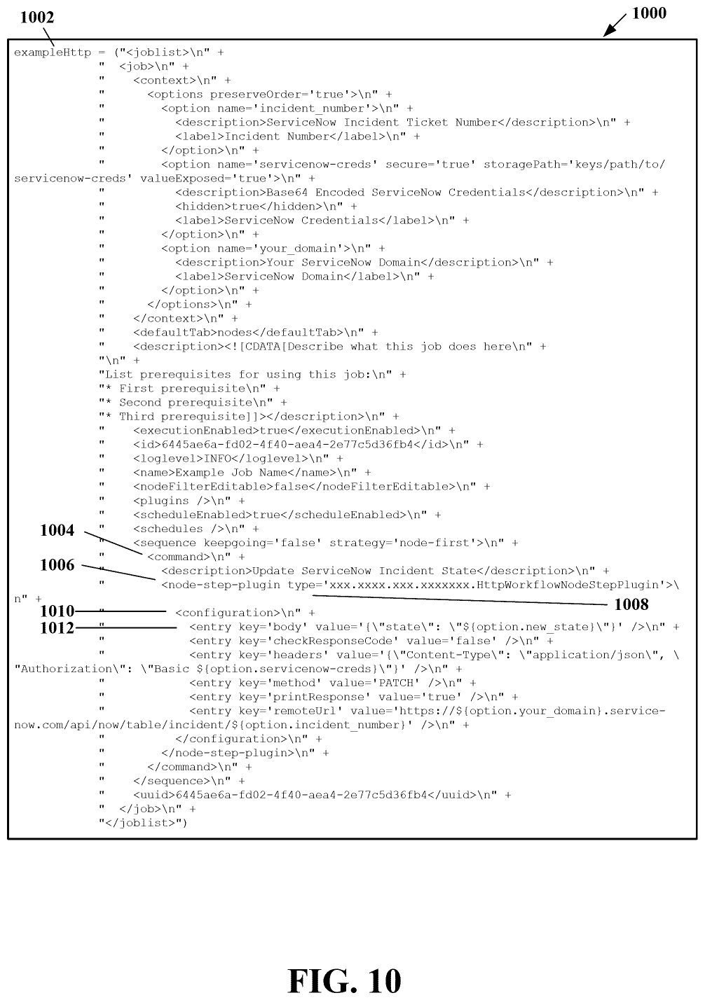

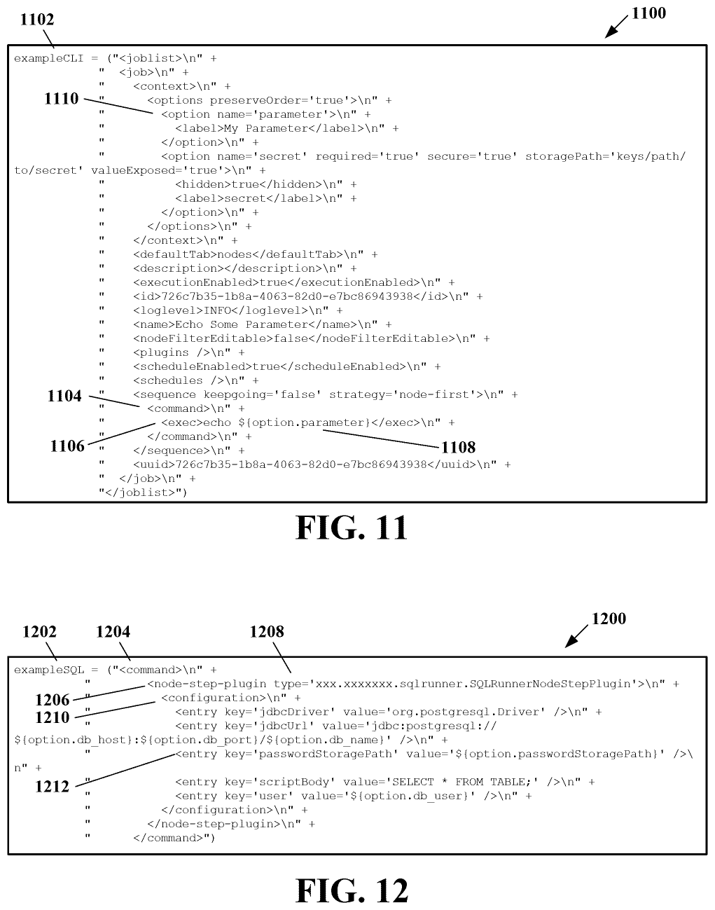

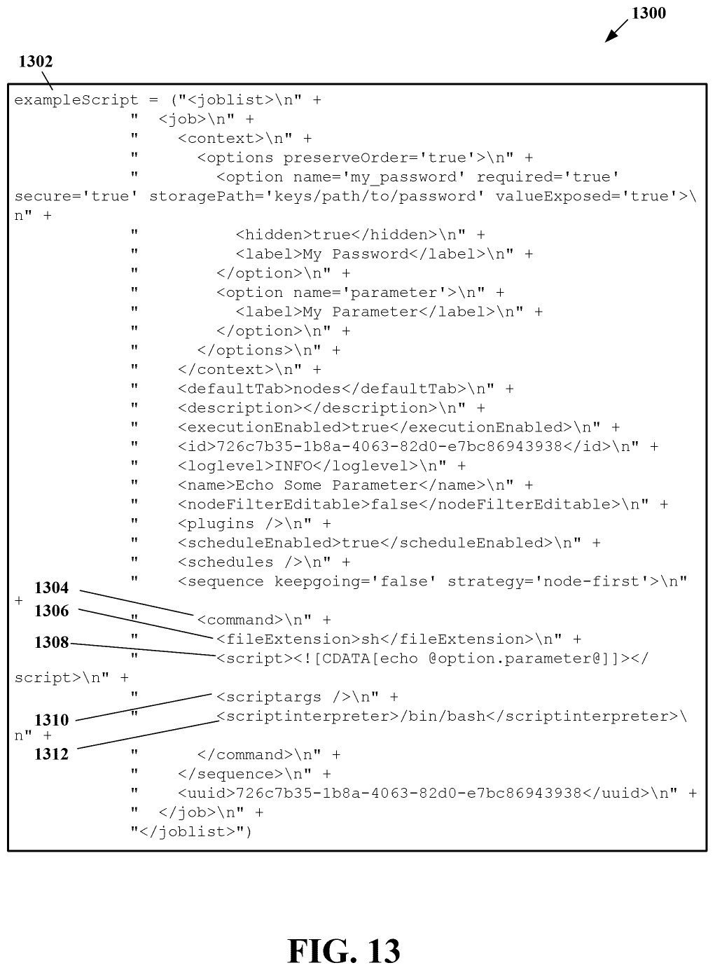

The job definition training datum 804 is described in more detail in reference to FIG. 9 below. The job definition training datum 806 is a template for how tasks utilizing the API or HTTP protocol may be structured. The job definition training datum 806 is described in more detail in reference to FIG. 10 below. The job definition training datum 808 is a template for how tasks utilizing the CLI protocol may be handled. The job definition training datum 808 is described in more detail in reference to FIG. 11 below. The job definition training datum 810 is a template for how tasks utilizing the SQL Query protocol may be handled. The job definition training datum 810 is described in more detail in reference to FIG. 12 below. Lastly, the job definition training datum 812 is a template for how tasks utilizing the Script protocol may be handled. The job definition training datum 812 is described in more detail in reference to FIG. 13 below.

FIG. 8B is an illustration of a suffix 820. The suffix 820 may be used to provide the language model with discrete instructions regarding how the language model is to format the job definition. For example, the suffix 820 describes that the job definition (e.g., Rundeck XML) may include a sequence tag 824, a name tag 826, and a description tag 828. Furthermore, the suffix 820 described at line 830 shows how variables (e.g., placeholders) that may be input by a user when the job is executed may be defined as opposed to variables that are not editable by a user at runtime. Specifically, the suffix instruction the language model to wrap all variables that may be input by a user at runtime in the following token “$ { },” whereas all other variables may be wrapped the following token “{ }.”

Furthermore, the suffix 820 instructs the language model that all steps may be wrapped within a command tag 832. To illustrate, a step to stop a service running on a Linux server may be “<command>systemct1 stop apache2</command>.” The suffix 820 also describes how the job definition job description 834 may be formatted and how structure any required prerequisites 836. Next the suffix 820 describes how secrets, password, API tokens or keys 838, or any other data that require privacy or security may be handled. Lastly the suffix 820 instructs the language model to ensure that the job definition is well formatted extensible markup language (XML) 840.

While the prefix and suffix depicted in FIGS. 8A and 8B describe the job description using Rundeck XML, the job definition may be formatted using any other suitable language or job type.

Alternatively, the detailed instructions to the language model as to how the job definition training data, the natural language description, and the series of tasks may be utilized to generate the job definition and the detailed instructions as to how the language model is to format the job definition may be combined together without the use of the prefix 802 or the suffix 820. FIG. 8C illustrates an example of a prompt 852 including the combination of the job definition training data, the natural language description, the series of tasks and the detailed instructions as to how the language model is to format the job definition. The prompt 852 provides the language model with job definition training data 854-862 and instructs the language model to generate a job definition for the natural language description (i.e., user_input 864) using the series of tasks (i.e., classifier_resposne 866).

The job definition training datum 854 is a template of a multi-step automation job definition. The job definition training datum 854 may be the same as or similar to the job definition training datum 804 of FIG. 8A. The job definition training datum 854 is described in more detail in reference to FIG. 9 below. The job definition training datum 856 is a template for how tasks utilizing the API or HTTP protocol may be structured. The job definition training datum 856 may be the same as or similar to the job definition training datum 806 of FIG. 8A. The job definition training datum 856 is described in more detail in reference to FIG. 10 below. The job definition training datum 858 is a template for how tasks utilizing the CLI protocol may be handled. The job definition training datum 858 may be the same as or similar to the job definition training datum 808 of FIG. 8A. The job definition training datum 858 is described in more detail in reference to FIG. 11 below.

The job definition training datum 860 is a template for how tasks utilizing the SQL Query protocol may be handled. The job definition training datum 860 may be the same or similar to the job definition training datum 810 of FIG. 8A. The job definition training datum 860 is described in more detail in reference to FIG. 12 below. The job definition training datum 862 is a template for how tasks utilizing the Script protocol may be handled. The job definition training datum 862 may be the same or similar to the job definition training datum 812 of FIG. 8A. The job definition training datum 862 is described in more detail in reference to FIG. 13 below.

Furthermore, the prompt 852 may be used to provide the language model with discrete instructions regarding how the language model is to format the job definition. For example, the prompt 852 describes that the job definition (e.g., Rundeck XML) may include a sequence tag 868 (e.g., such as the sequence tag 824 of FIG. 8B), a name tag 870 (e.g., such as the name tag 826 of FIG. 8B), and a description tag 872 (e.g., such as the description tag 828 of FIG. 8B). Furthermore, the prompt 852 described at line 874 shows how variables (e.g., placeholders) that may be input by a user when the job is executed may be defined as opposed to variables that are not editable by a user at runtime. Specifically, the suffix instruction the language model to wrap all variables that may be input by a user at runtime in the following token “$ { },” whereas all other variables may be wrapped the following token “{ }.”

Furthermore, the prompt 852 instructs the language model that all steps may be wrapped within a command tag 876 (e.g., such as the command tag 832 of FIG. 8B). To illustrate, a step to stop a service running on a Linux server may be “<command>systemct1 stop apache2</command>.” The prompt 852 also describes how the job definition job description 878 may be formatted and how to structure any required prerequisites 880. Next the prompt 852 describes how secrets, password, API tokens or keys 882, or any other data that require privacy or security may be handled. Lastly the prompt 852 instructs the language model to ensure that the job definition is well formatted extensible markup language (XML) 884.

While the prompt in FIB. 8C describes the job description using Rundeck XML, the job definition may be formatted using any other suitable language or job type.

FIG. 9 is an illustration of a job definition template 902. The job definition template 902 may be the job definition training datum 804 of FIG. 8. The job definition template 902 may be used by the language model to configure itself to learn how to return the job definition according to the job definition template 902. The job definition template 902 includes elements 904-918. Each element of the job definition template 902 is used by the language model to configure itself to learn how different elements within the job definition may be formatted.

The job element 904 may be used by the language model to help learn how to define a job within the job definition. For example, according to the job element 904, a job is defined using XML node syntax to denote the beginning of the job node (i.e., “<job>”). The description element 906 and the name element 908 may be used by the language model to help learn how the description tag 828 and the name tag 826 of FIG. 8B may be formatted. The sequence element 910 may be used by the language model to help learn how the sequence tag 824 of FIG. 8 is defined within the job definition. Additionally, the command elements 912-918 may be used by the language model to help learn how commands may be formatted.

The command element 912 is an example of a CLI command. The CLI command may be described further in reference to FIG. 11. FIG. 11 is an illustration 1100 of a job definition 1102 using a CLI command 1104. The job definition 1102 may be the job definition training datum 808 of FIG. 8. The CLI command 1104 includes an exec node 1106. The exec node 1106 may contain the computer implementable or executed instructions. For example, the exec node 1106 may include the computer implementable or executed instruction of “echo $ {option. parameter}.” Additionally, the exec node includes a variable 1108 as described by line 830 of FIG. 8B. The variable 1108 may be defined by the option node 1110. The option node 1110 may be defined by the name element of the node. For example, the option node 1110 may be defined as “<option name=′parameter′>” as such the name of the variable may be denoted as option.parameter. Furthermore, the variable 1108 may be defined with the exec node 1106 using the “$ { }” to indicate that the value for the parameter may be supplied by the user at runtime.

The command element 914 is an example of an HTTP command. The HTTP command may be described further in reference to FIG. 10. FIG. 10 is an illustration 1000 of a job definition 1002 using a HTTP command 1004. The job definition 1002 may be the job definition training datum 806 of FIG. 8. The HTTP command 1004 may also be used for executing API commands. The HTTP command 1004 may include a plugin node 1006. The plugin node 1006 may allow the command to execute commands that may be defined outside of the system 400. The plugin node may have a type element 1008. The type element 1008 may be used to specify the type of the plugin to use. Additionally, the HTTP command 1004 may include a configuration node 1010. The configuration node may be used to configure the plugin node 1006. The configuration node 1010 may configure the plugin node 1006 using one or more entry nodes 1012. The entry nodes may be used to define different parameters for the plugin node 1006. Each entry node 1012 may have a key and a value. The key may be used to set the name of the parameters while the value may be used to set the value for the parameter. The values may be static values or the values may be set using variables. The variables may be set using the option parameters as described in reference to FIG. 11 above.

The command element 916 is an example of a SQL Query command. The SQL Query command may be described further in reference to FIG. 12. FIG. 12 is an illustration 1200 of a job definition 1202 using a SQL Query command 1204. The job definition 1202 may be the job definition training datum 810 of FIG. 8. The SQL Query command 1204 may include a plugin node 1206. The plugin node 1206 allows the command to execute commands that may be defined outside of the system 400. The plugin node may have a type element 1208. The type element 1208 may be used to specify the type of the plugin to use. Additionally, the SQL Query command 1204 may include a configuration node 1210. The configuration node may be used to configure the plugin node 1206. The configuration node 1210 may configure the plugin node 1206 using one or more entry nodes 1212. The entry nodes may be used to define different parameters for the plugin node 1206. Each entry node 1212 may have a key and a value. The key may be used to set the name of the parameters while the value may be used to set the value for the parameter. The values may be static values or the values may be set using variables. The variables may be set using the option parameters as described in reference to FIG. 11 above.

The command element 918 is an example of a Script command. The Script command may be described further in reference to FIG. 13. FIG. 13 is an illustration 1300 of a job definition 1302 using a script command 1304. The job definition 1302 may be the job definition training datum 812 of FIG. 8. The script command 1304 may contain a file extension node 1306. The file extension node 1306 may be used to define the type of file extension associated with the script command 1304. The script command 1304 may also include a script node 1308. The script node 1308 may define the name of the script file that should be included or alternatively, the script tag may contain the contents of the script file as a string literal. The script command 1304 may also include a script arguments node 1310. The script arguments node 1310 may be used to define arguments that may be used when the script is executed by the system 400. Lastly, the script command 1304 may include a script interpreter node 1312. The script interpreter node 1312 may be used to define how the script may be executed within the system 400.

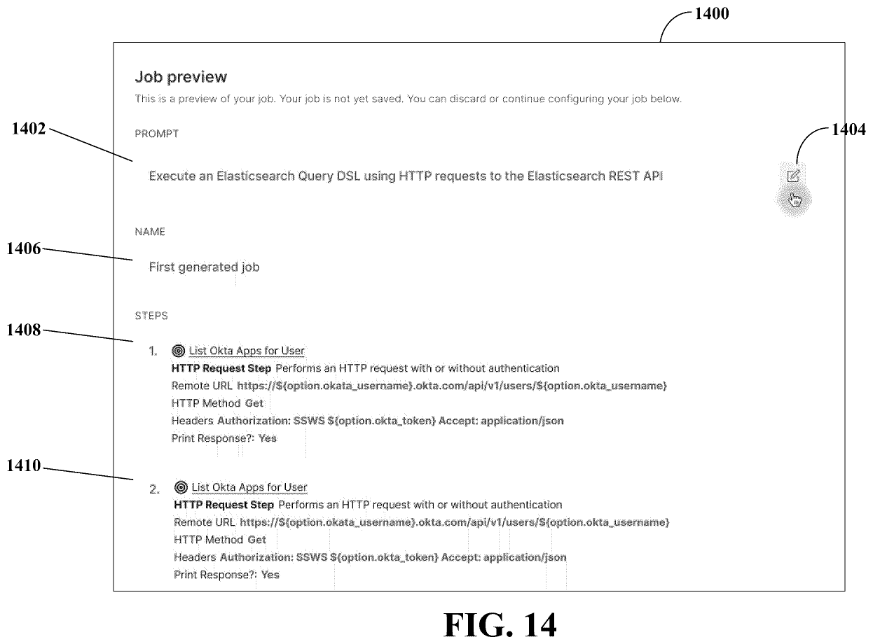

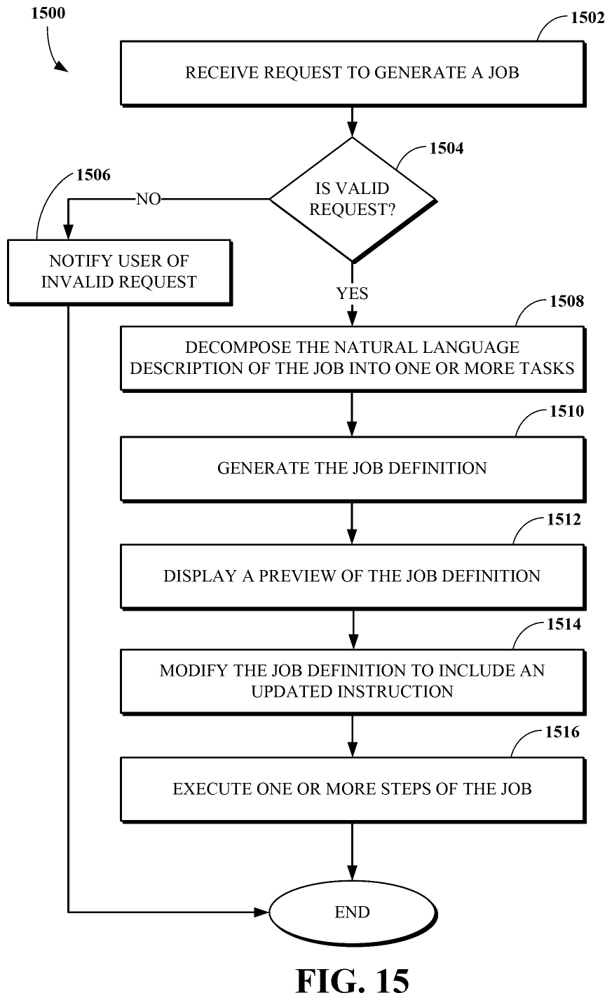

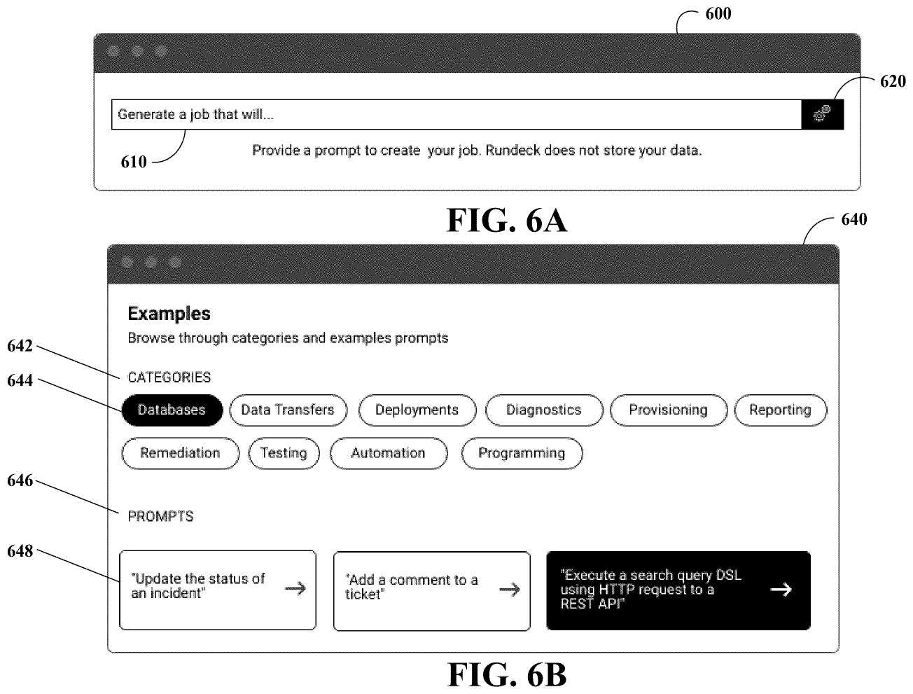

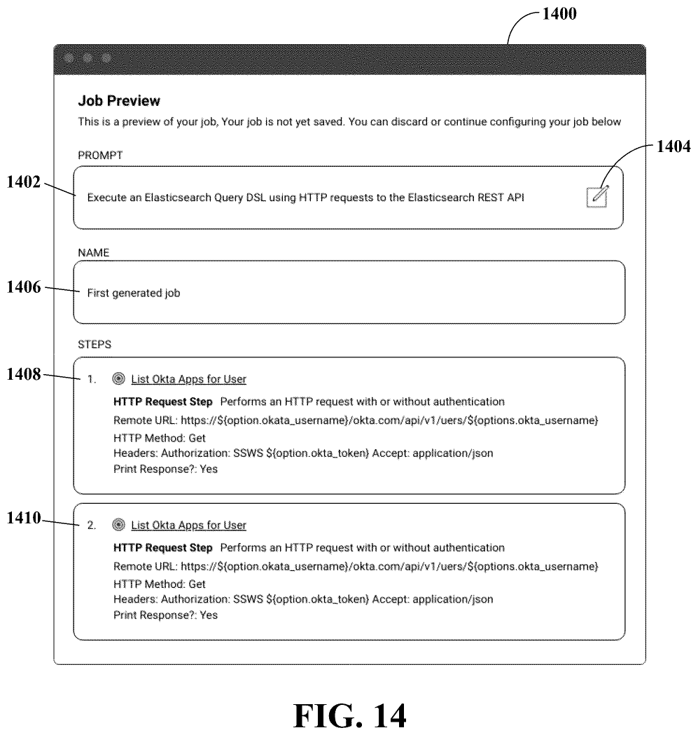

Referring again to FIG. 5, At operation 514, the job definition is received from the language model. The job definition may be stored in the data store 410. Additionally, the job definition may be displayed to the user, such as is described in FIG. 14. FIG. 14 illustrates a user interface 1400 for previewing the received job definition. The user interface 1400 includes element 1402 for displaying the natural language description received from the user, such as via the job description input field 610 of FIG. 6. Additionally, the user interface 1400 includes a command button 1404 that, when invoked, enables the user to edit the natural language description. Invoking (i.e., selecting, pressing, touching, tapping, or clicking) the command button 1404 may navigate the user to the user interface 600. This may allow a user to change the natural language description used to generate the job definition. As such control may return to operation 502.

The name element 1406 displays the name defined in the job definition by the language model. Below the name element 1406, the series of steps generated for the job definition are displayed. Step 1408 shows the various details for the given step. For example, the name of the step 1408 is “List Okta Apps for User.” The step 1408 will make an HTTP request to a remote endpoint using the HTTP Get method. Furthermore, the HTTP request contains a variable for option.okta_username (i.e., $ {option.okta_username}). The steps also contains a header attribute with an additional variable to be supplied by the user when the job is executed. The header includes the variable $ {option.okta_token}, lastly the step defines whether the response of the HTTP Get request may be printed out to the user.

While two steps are shown in the current example, a job definition may include fewer or more steps as appropriate for the goals of the request. In some embodiments the job definition may include only one step, while other embodiments may include several steps. There is no set number of steps that must be included within a job definition as long as there is at least one step.

Referring again to FIG. 5, operation 516 executes one or more steps of the job. After the job definition is received at operation 514 and the user previews the job definition, the job definition can be saved as a job and may be executed at a later point in time. The job can be executed manually by a user, or triggered in response to an event, such as the event 410A or the event 410B of FIG. 4, an incident, or as a step within a different job. In an example, the job may be referenced from a workflow. For example, a workflow step may cause the job definition to be, for example, instantiated (where parameters or variables are resolved), and executed.

FIG. 15 includes a flowchart diagram of a technique 1500 for smart job definition for incident response. The technique 1500 includes operations 1502 through 1516, which are described below. The technique 1500 can be stored in one or more memories (such as the memory 304, the processor readable stationary storage 334, the processor readable removeable storage 336 of FIG. 3, or any combination thereof of one or more network computers) as instructions that can be executed by one or more processors (such as the processor 302 of FIG. 3) of one or more computers. In some implementations, some or all operations of the technique 1500 may be performed on a client computer, such as by the client computer 101-104. In some other implementations, some or all operations of the technique 1500 may be performed at the enclosure 120 or the enclosure 122, such as by the operations management server computer 116 at the data center 118.

At operation 1502, a request to generate a job is received. The request to generate a job may be as described with respect to the operation 502 of FIG. 5.

At operation 1504, the technique 1500 determines whether the request is valid. Determining whether the request is valid can be as described with respect to the operation 504 of FIG. 5. As such the operation 1504 may mark the request as invalid if the request is determined to be invalid. If the request is determined to be valid, the technique 1500 proceeds to operation 1508; otherwise, the technique 1500 proceeds to operation 1506.

At operation 1506, a notification is displayed to a user indicating that the request is invalid. The invalid request notification may be displayed in response to a determination from operation 1504 that the request does not pertain to automation.

At operation 1508, the natural language description of the job is decomposed into one or more tasks. A job decomposition request may be transmitted to a language model, such as described with respect to the operation 508 of FIG. 5. A series of tasks generated by the language model may be received from the language model based on the job decomposition request, such as described with respect to the operation 510 of FIG. 5.

At operation 1510, the job definition is generated. As described above, a job definition generation request may be transmitted to the language model and the job definition may be received from the language model.

At operation 1512, a preview of the job definition is displayed. The job definition may be displayed using a user interface, such as the user interface 1400 of FIG. 14.

At operation 1514, the job definition may be modified to include an updated instruction. The operation 1514 may receive an updated instruction from the user or from another component within the system 400, such as service 406A-406B or service 408A-408B. An updated instruction may be received via a user interface, an API or the like. The updated instruction may replace an entire instruction or only a portion of the instruction. In either case, the job definition may be modified based on the updated instruction. The updated instruction may be displayed as a part of the preview of the job definition as described above in reference to operation 1512.

At operation 1516, the technique 1500 executes one or more steps of the job. Executing the one or more steps can be as described with respect to the operation 516 of FIG. 5.

For simplicity of explanation, the techniques 500 and 1500 of FIGS. 5 and 15 are depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “software” refers to logic embodied in hardware or software instructions, which can be written in a programming language, such as C, C++, Objective-C, COBOL, Java™, PHP, Perl, JavaScript, Ruby, VBScript, Microsoft.NET™ languages such as C#, and/or the like. A software may be compiled into executable programs or written in interpreted programming languages. Software may be callable from other software or from themselves. Software described herein refer to one or more logical modules that can be merged with other software or applications, or can be divided into sub-software or tools. The software can be stored in non-transitory computer-readable medium or computer storage devices and be stored on and executed by one or more general purpose computers, thus creating a special purpose computer configured to provide the software.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

1. A method, comprising:
receiving a natural language request to generate a job definition, wherein the natural language request includes a natural language description of a job executable by a computing device;
decomposing the natural language description of the job into one or more tasks, wherein each task of the one or more tasks is a natural language description of a portion of the job;
generating the job definition comprising one or more instructions, wherein at least one instruction of the one or more instructions corresponds to a task of the one or more tasks, such that performance of the at least one instruction accomplishes the task; and
executing, by the computing device, the job definition to perform the job in response to an incident.

2. The method of claim 1, wherein the decomposing of the natural language request comprises:
transmitting the natural language description of the job and training data to a language model; and
receiving the one or more tasks from the language model.

3. The method of claim 1, wherein the generating the job definition comprises:
transmitting the one or more tasks and training data to a language model; and
receiving, from the language model, the job definition.

4. The method of claim 1, wherein the natural language request is a first natural language request, the method further comprising:
receiving a second natural language request;
determining that the second natural language request is invalid; and
responsive to determining that the second natural language request is invalid, notifying a user.

5. The method of claim 1, further comprising:
displaying the job definition to a user; and
modifying the job definition to include an updated instruction.

6. The method of claim 5, wherein the modifying the job definition comprises:
receiving the updated instruction from the user.

7. The method of claim 1, wherein a task of the one or more tasks includes a protocol, wherein the protocol describes a mechanism used to perform the task.

8. A system, comprising:
one or more memories; and
one or more processors, the one or more processors configured to execute instructions stored in the memory to:
receive a natural language request to generate a job definition, wherein the natural language request includes a natural language description of a job, and wherein the job is capable of being performed, at least in part, by a computing device;
decompose the natural language description of the job into one or more tasks, wherein each task of the one or more tasks is a natural language description of a portion of the job;
generate the job definition comprising one or more instructions, wherein at least one instruction of the one or more instructions corresponds to a task of the one or more tasks, such that performance of the at least one instruction accomplishes the task; and
execute, by the computing device, the job definition to perform the job in response to an incident.

9. The system of claim 8, wherein to decompose the natural language request comprises to:
transmit the natural language description of the job and training data to a language model; and
receive, from the language model, the one or more tasks.

10. The system of claim 8, wherein to generate the job definition comprises to:
transmit the one or more tasks and training data to a language model; and
receive, from the language model, the job definition.

11. The system of claim 8, wherein the natural language request is a first natural language request and the one or more processors are further configured to execute instructions stored in the one or more memories to:
receive a second natural language request;
determining that the second natural language request is invalid; and
responsive to a determination that the second natural language request is invalid, notify a user.

12. The system of claim 8, wherein the one or more processors are further configured to execute instructions stored in the one or more memories to:
display the job definition to a user; and
modify the job definition to include an updated instruction.

13. The system of claim 12, wherein to modifying the job definition comprises to receive the updated instruction from the user.

14. The system of claim 8, wherein a task of the one or more tasks includes a protocol, wherein the protocol describes a mechanism used to perform the task.

15. One or more non-transitory computer readable media storing instructions operable to cause one or more processors to perform operations comprising:
receiving a natural language request to generate a job definition, wherein the natural language request includes a natural language description of a job, and wherein the job is capable of being performed, at least in part, by a computing device;
decomposing the natural language description of the job into one or more tasks, wherein each task of the one or more tasks is a natural language description of a portion of the job;
generating the job definition comprising one or more instructions, wherein at least one instruction of the one or more instructions corresponds to a task of the one or more tasks, such that performance of the at least one instruction accomplishes the task; and
executing, by the computing device, the job definition to perform the job in response to an incident.

16. The one or more non-transitory computer readable media of claim 15,
wherein the decomposing of the natural language request comprises:
transmitting the natural language description of the job and training data to a language model; and
receiving, from the language model, the one or more tasks.

17. The one or more non-transitory computer readable media of claim 15, wherein generating the job definition comprises:
transmitting to a language model, the one or more tasks and training data; and
receiving, from the language model, the job definition.

18. The one or more non-transitory computer readable media of claim 15, wherein the natural language request is a first natural language request, the operations further comprise:
receiving a second natural language request;
determining that the second natural language request is invalid; and
responsive to a determination that the second natural language request is invalid, notifying a user.

19. The one or more non-transitory computer readable media of claim 15, wherein the operations further comprise:
displaying the job definition to a user; and
in response to receiving an updated instruction from the user, modifying the job definition to include the updated instruction.

20. The one or more non-transitory computer readable media of claim 15, wherein a task of the one or more tasks includes a protocol, wherein the protocol describes a mechanism used to perform the task.
